(19) United States
(12) Patent Application Publication
(10) Pub. No.: US 2025/0377745 A1
(43) Pub. Date: Dec. 11, 2025

(54) USER INTERFACE APPARATUS

(71) Applicant: Qorvo US, Inc., Greensboro, NC (US)

(72) Inventors: Omar Leung, Palo Alto, CA (US); Bryan Low, San Mateo, CA (US); Victor Sutardja, Saratoga, CA (US); Paul Badalian, Mogan Hill, CA (US); Ilya Umansky, San Jose, CA (US)

(21) Appl. No.: 19/215,544

(22) Filed: May 22, 2025

Related U.S. Application Data
(60) Provisional application No. 63/658,004, filed on Jun. 10, 2024.

(51) Int. Cl. G06F 3/041; G06F 3/0354

(52) U.S. Cl. CPC G06F 3/0414; G06F 3/03547; G06F 3/0416; G06F 2203/0339

(57) ABSTRACT

A user interface apparatus is disclosed, having a housing, an elongated pad on the exterior surface, a first strain sensor near the proximal end of the pad and fixed to the interior surface, and a second strain sensor near the distal end of the pad and fixed to the interior surface. The first strain sensor generates a first electrical signal with a maximum magnitude when force is applied directly to the proximal end, decreasing in magnitude as force is applied further away. Similarly, the second strain sensor generates a second electrical signal with a maximum magnitude when force is applied directly to the distal end, decreasing in value as force is applied further away. This user interface apparatus is configured to detect force applied to the elongated pad at points between the proximal end and the distal end, providing a floating slider function for various applications.

### RELATED APPLICATIONS

This application claims the benefit of provisional patent application Ser. No. 63/658,004, filed Jun. 10, 2024, the disclosure of which is hereby incorporated herein by reference in its entirety.

### FIELD OF THE DISCLOSURE

The present disclosure relates to a user interface apparatus with sensors that detect strain, utilizing nearby stress concentration regions. Such input structures are particularly useful for manually operated controls in electronic systems such as computers, cameras, and video games.

### BACKGROUND

A floating slider is an input device used to specify position within a range. Position values are typically within the range of the slider, and the position resolution is implementation specific. The floating slider generates electrical signals that update a position value of a pointing instrument such as a human finger. As the pointing instrument interacts with the floating slider, the electrical signals increment or decrement the position value that points to a discrete position. Electronic devices that require waterproof housing and translational interaction, such as a floating slider, require a method and structural configuration to seal associated electronics within the housing. Thus, there is a need for a user interface apparatus configured to provide a floating slider function that is usable in harsh environments such as underwater environments.

### Summary

A user interface apparatus is disclosed. The user interface apparatus includes a housing, an elongated pad disposed over an interior surface and extending outwardly from an exterior surface, a first strain sensor aligned with a proximal end of the elongated pad and fixed to the interior surface, and a second strain sensor aligned with a distal end of the elongated pad and fixed to the interior surface. The first strain sensor generates a first electrical signal that is at a maximum value when force is applied directly to the proximal end of the elongated pad and decreases in value as force is progressively applied to the elongated pad at increasing distance from the proximal end. The second strain sensor generates a second electrical signal that is at a maximum value when force is applied directly to the distal end of the elongated pad and decreases in value as force is progressively applied to the elongated pad at increasing distance from the distal end.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a diagram depicting an exemplary embodiment of a user

interface apparatus that is structured in accordance with the present disclosure to include an elongated pad to provide a floating slider function.

FIG. 2 is a side view of the housing showing a clearer view of an internal elements within a housing making up the user interface apparatus.

FIG. 3 is a diagram of a first exemplary support structure to hold strain sensors against an interior surface of the housing.

FIG. 4 is a diagram of a second exemplary support to hold the strain sensors against the interior surface of the housing.

FIG. 5 is a diagram of a third exemplary support structure to hold the strain sensors against the interior surface of the housing.

FIG. 6 is a diagram depicting a human finger touching a proximal end of the elongated pad to apply a full force against the proximal one of the strain sensors and practically no force against the distal one of the strain sensors.

FIG. 7 is a diagram depicting a human finger touching the elongated pad midway between the proximal end and the distal end to apply relatively equal force against the strain sensors.

FIG. 8 is a diagram depicting a human finger touching a distal end of the elongated pad to apply a full force against a distal one of the strain sensors and practically no force against a proximal one of the strain sensors.

FIG. 9 is the diagram of an exemplary electronic system in which the concepts of the user interface apparatus may be implemented.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

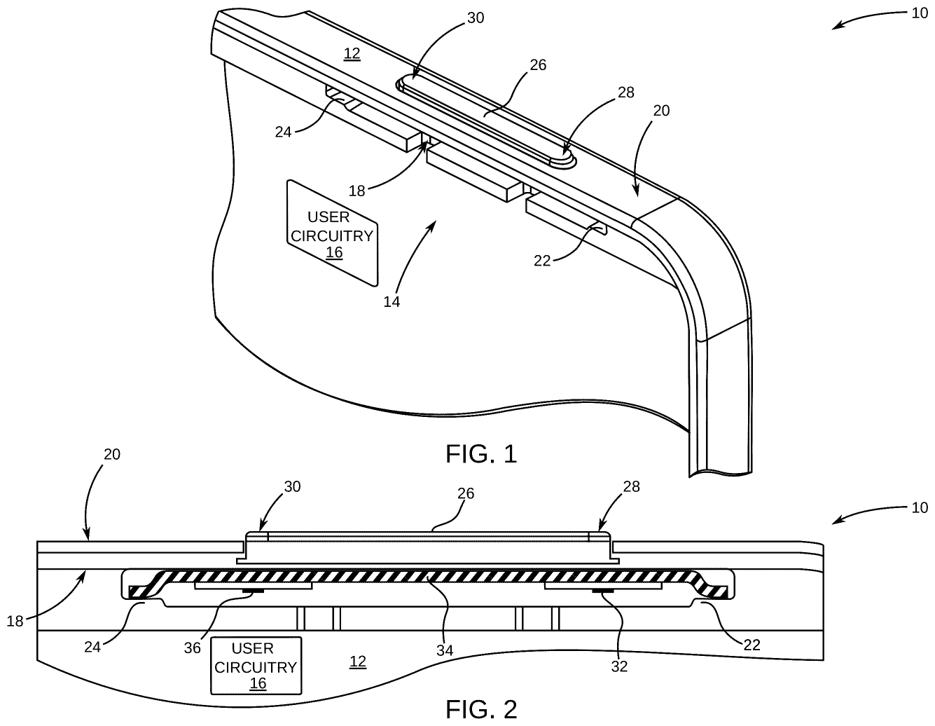

Disclosed are embodiments of a user interface apparatus that is configured to provide a slider function in a contiguous manner with resolution to the fraction of a millimeter. FIG. 1 is a diagram depicting an exemplary embodiment of a user interface apparatus 10 that is structured in accordance with the present disclosure. The user interface apparatus 10 includes a housing 12 with a substantially hollow interior 14 in which user circuitry 16 is housed. The view in FIG. 1 shows a cut view of the housing 12 that in complete form is generally box shaped. However, it is to be understood that the housing may be in the form of other shapes such as cylinder and various custom shapes that have a hollow interior for housing user circuitry 16 and supporting devices.

The housing 12 has an interior surface 18 and an exterior surface 20. In the exemplary embodiment of FIG. 1, the housing 12 includes a proximal mounting ledge 22 and a distal mounting ledge 24 for mounting sensors (not shown in this view).

In some embodiments the housing 12 is hermetically sealed to protect the user circuitry 16 from hazardous environments such as an underwater environment. In some embodiments the hollow interior 14 of the housing is waterproof to a water depth of up to 100 meters. In other embodiments, the housing is waterproof up to a water depth of 300 meters. The housing 12 may be made of metal, plastic, and/or composite materials such as carbon fiber and resin.

The user interface apparatus 10 further includes an elongated pad 26 that is configured to provide a manual input function for a user to manipulate in order to interact with the user circuitry 16. The elongated pad 26 is disposed over the interior surface 18 and extends outwardly from the exterior surface 20. The elongated pad 26 has a proximal end 28 and a distal end 30.

FIG. 2 shows a side view of the housing 12 that includes the elongated pad 26. A first strain sensor 32 is aligned with the proximal end 28 of the elongated pad 26 and is fixed to the interior surface 18 by way of a support structure 34 that is captured between the interior surface 18, the proximal mounting ledge 22 and the distal mounting ledge 24. A second strain sensor 36 is aligned with the distal end 30 of the elongated pad 26 and is fixed to the interior surface 18 by way of the support structure 34. The support structure 34 may be a metal, plastic, or composite strip to which the first strain sensor 32 and the second strain sensor 36 are fixed. For example, the first strain sensor 32 and the second strain sensor 36 may be fixed by typical methods such as gluing, fastening with fasteners, or ultrasonic welding.

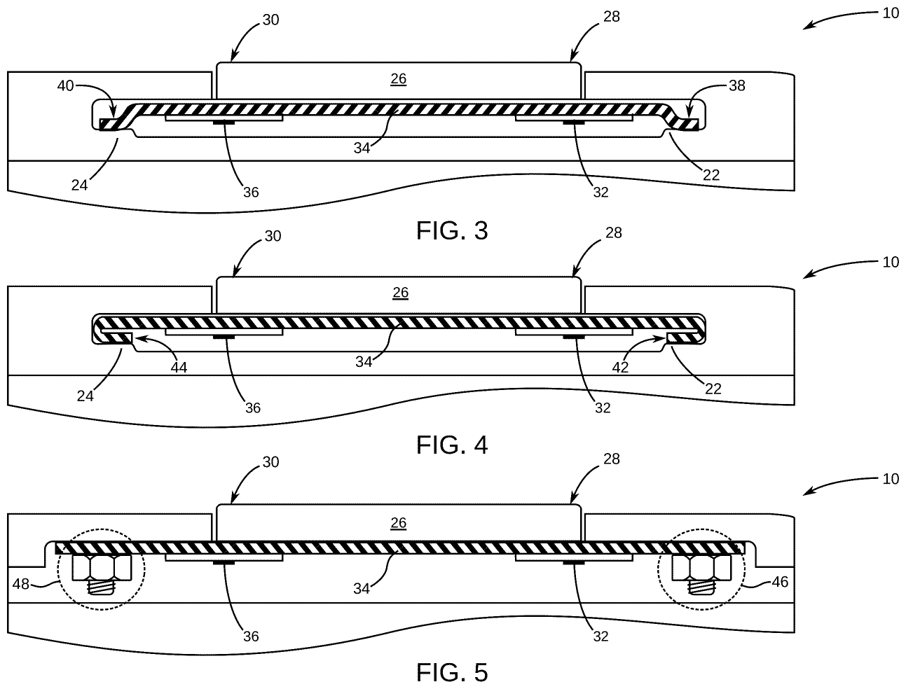

FIGS. 3, 4, and 5 provide side cut views of the housing 12 that focus on exemplary configurations for the support structure 34. In FIG. 3, the support structure 34 has a proximal foot 38 that presses against the proximal mounting ledge 22 and forces a portion of support structure 34 that holds the first strain sensor 32 against the interior surface 18. The support structure 34 further includes a distal foot 40 that presses against the distal mounting ledge 24 and forces a portion of support structure 34 that holds the second strain sensor 36 against the interior surface 18.

In FIG. 4, the support structure 34 has a proximal folded foot 42 that presses against the proximal mounting ledge 22 and forces the portion of support structure 34 that holds the first strain sensor 32 against the interior surface 18. The support structure 34 further includes a distal folded foot 44 that presses against the distal mounting ledge 24 and forces the portion of support structure 34 that holds the second strain sensor 36 against the interior surface 18.

In FIG. 5, the support structure 34 employs a proximal mechanical fastener 46 that pulls the portion of support structure 34 that holds the first strain sensor 32 against the interior surface 18. The support structure 34 further includes a distal mechanical fastener 48 that pulls the portion of support structure 34 that holds the second strain sensor 36 against the interior surface 18. As depicted in FIG. 5, the proximal mechanical fastener 46 is a first bolt and nut pair shown within a first dashed circle and the distal mechanical fastener 48 is a second bolt and nut pair shown with a second dashed circle. However, it is to be understood that other types of mechanical fasteners such as screws may be used without limiting the scope of the present disclosure. Moreover, in some embodiments, the support structure 34 may be glued against the interior surface 18.

For this disclosure, a strain sensor like the first strain sensor 32 and the second strain sensor 36 is defined as a type of mechanical transducer that converts the application of an external force into a change in electrical resistance. The sensing element is made up of a material with a specific electrical resistance that experiences a change in resistance when it is subjected to strain. The deformation caused by the applied force alters the geometry or microstructure of the sensing material, leading to a variation in its electrical resistance. This resistance change can be measured and calibrated to determine the level of strain or force being applied. Strain sensors suitable for use as the first strain sensor 32 and the second strain sensor 36 typically generate low-level direct current (DC) electrical signals, specifically, changes in resistance or voltage that are proportional to the amount of mechanical strain they experience.

In some embodiments, the first strain sensor 32 and the second strain sensor 36 are each a micro-electromechanical systems (MEMS) strain sensor. The MEMS-type strain sensor is a relatively miniature sensor used to measure mechanical deformation or strain. Similar to the previous strain sensor type, the MEMS strain sensor operates based on the principle of piezoresistivity, where the resistance of the material changes in response to applied stress or strain. MEMS strain sensors are fabricated using semiconductor technology and are made up of thin-film resistive elements that undergo a change in resistance when deformed. Electrical signals representing strain are then measured/detected and processed to determine the magnitude and location of the applied force applied to the elongated pad 26.

In yet other embodiments, a common type of strain sensor suitable as the first strain sensor 32 and second strain sensor 36 is the bonded metallic foil strain sensor, which consists of a relatively thin piece of metal foil arranged in a grid pattern and bonded to a substrate. When subjected to mechanical strain, the resistance of this metal foil changes due to a phenomenon called the piezoresistive effect. The resistance change is then converted into proportional electrical signals, usually in the form of a small change in voltage, using a bridge circuit and a voltage or current source. The resulting electrical signal is usually within a millivolt range and is typically processed using amplifiers and data acquisition systems and is used to determine the amount of strain or stress experienced by the first strain sensor 32 and the second strain sensor 36.

In some embodiments, the first strain sensor 32 and the second strain sensor 36 are each a printed ink strain gauge made up of a flexible substrate such as polyimide film or Kapton, a conductive layer applied using printing techniques such as inkjet or flexographic, an active layer with piezoresistive materials or other resistive elements also produced by printing, and connection pads for connecting the strain gauge to processing circuitry.

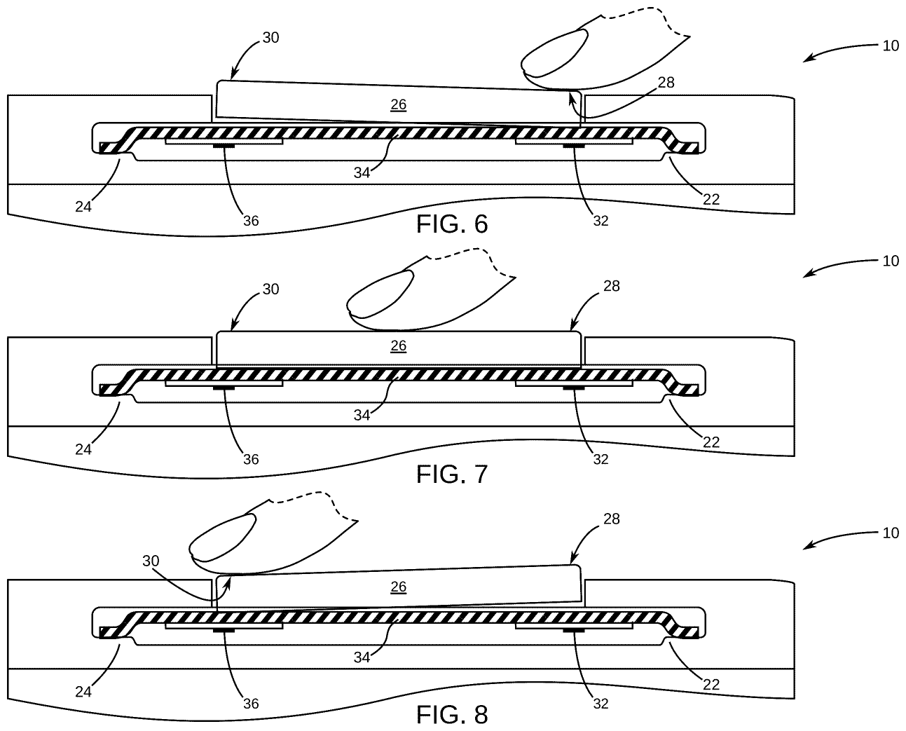

FIG. 6 is a diagram depicting a human finger touching the proximal end 28 of the elongated pad 26 to apply a full-scale force against the first strain sensor 32 and practically no force against the second strain sensor 36. This is a result of the first strain sensor 32 being configured to generate the first electrical signal that is at a maximum value when force is applied directly to the proximal end 28 of the elongated pad 26 and a decreasing in magnitude as force is progressively applied to the elongated pad 26 at increasing distance from the proximal end 28. In the case depicted in FIG. 6, the first electrical signal generated by the first strain sensor 32 is substantially full-scale in magnitude and the second electrical signal generated by the second strain sensor 36 is substantially zero in magnitude.

FIG. 7 is a diagram depicting a human finger touching a midpoint of the elongated pad 26 to apply relatively equal force against the first strain sensor 32 at the proximal end 28 and the second strain sensor 36 at the distal end 30. This is a result of the second strain sensor 36 being configured to generate the first electrical signal that is at a maximum value when force is applied directly to the distal end 30 of the elongated pad 26 and decreasing in magnitude as force is progressively applied to the elongated pad 26 at increasing distance from the distal end 30. In this case, the first electrical signal generated by the first strain sensor 32 and the second electrical signal generated by the second strain sensor 36 are substantially equal in magnitude.

FIG. 8 is a diagram depicting a human finger touching the distal end 30 of the elongated pad 26 to apply a full-scale force against the second strain sensor 36 and practically no force against the first strain sensor 32. In the case of FIG. 8, the first electrical signal generated by the first strain sensor 32 is substantially near zero magnitude and the second electrical signal generated by the second strain sensor 36 is substantially full-scale in magnitude.

Typically, the first stain sensor 32 and the second strain sensor 36 are located at the minimum and maximum offset range of the elongated pad 26, but in other embodiments the first strain sensor 32 and the second strain sensor 36 are displaced from the range endpoints. The elongated pad 26 reclines on springy material, which may be the housing portion between the support structure 34 and which acts a lever. Once pressure is applied, the elongated pad 26 reclines. The recline amplitude is proportional to the position of the pressure point within the strip. The amplitude of the recline is different at the opposite ends of the strip and is a function of the pressure point position and of the pressure force.

Sensor count values derived from the first electrical signal and the second electrical signal, respectively, may be uniquely mapped into position where pressure is applied. Pressure can be taken out of the mapping function because the swing amplitude increase at one end is accompanied by the proportional amplitude decrease at the opposite end. Thus, the position is a mapping of amplitude swings at the endpoints of the elongated pad 26. The amplitude swing is detected by the first strain sensor 32 and the second strain sensor 36 and thus can be detected as a sensor count values, wherein

$$Position = Function ( Count ( Sensor 1 ) , Count ( Sensor2 ) ) .$$

The springing characteristic of the elongated pad and housing 12 is preferred not to be hysteretic. Also, the elongated pad 26 is restrained from lateral movements. These conditions are to achieve linearity of the position function. A non-linear mapping function or set of functions with dependencies on pressure force are not desirable as it complicates manufacturing and requires a complex calibration procedure. Though a non-linear mapping function or set of functions is not desirable, it may not be avoidable for certain material choices.

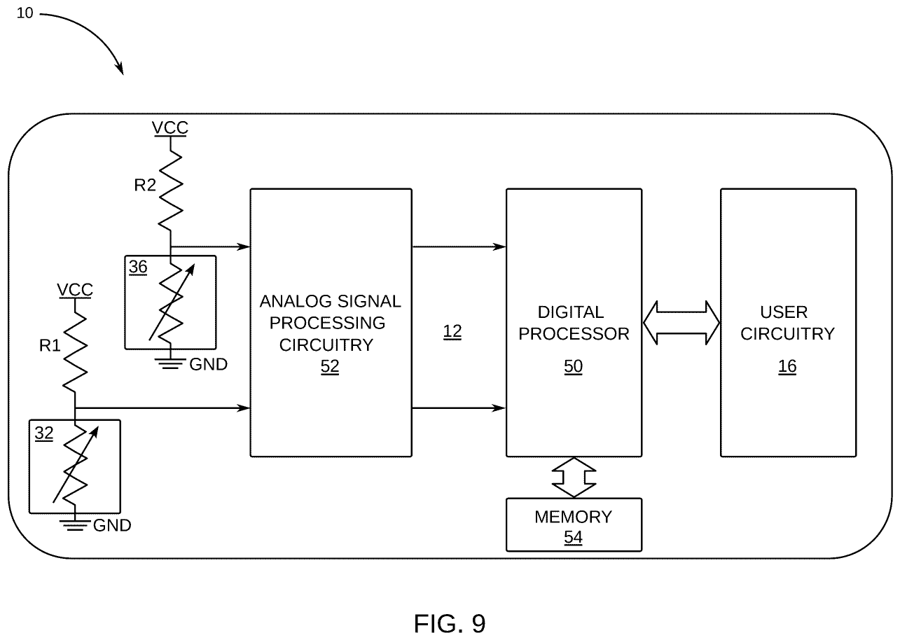

With reference to FIG. 9, the concepts described above may be implemented for various types of electronic systems such as the user circuitry 16 that may make up a digital camera, a game controller, a handheld robot controller, and the like that require manual user input. The user circuitry 16 generally interfaces with or includes a digital processor 50 and analog signal processing circuitry 52 coupled between the first strain sensor 32, the second strain sensor 36, and the digital processor 50. A first resistor R1 and a second resistor R2 form voltage dividers between the first strain sensor 32 and the second strain sensor 36, respectively. The voltage dividers are both coupled between an excitation source VCC and a ground GND. The analog signal processing circuitry 52 typically includes amplifiers and filters (not shown) that cooperate to amplify and remove noise from the first electrical signal and the second electrical signal.

The digital processor 50 typically includes an analog-to-digital converter (not shown) that converts amplified and filtered versions of the first and second electrical signals into first and second digital signals, respectively. The digital processor 50 then processes the first and second digital signals to extract the information that determines the location of where the elongated pad 26 is pressed. This processing may also comprise error correction operations and other decoding such as detecting the direction of press travel by comparing immediately previous press locations with a present press location. The digital processor 50 may be implemented in one or more digital signal processors (DSPs) and application-specific integrated circuits (ASICs) and be interfaced with a memory 54 in which firmware is stored. The firmware includes instructions for controlling the processing that determines user input. Further signal processing details will be understood by those skilled in the art.

At least a first advantage of the user interface apparatus 10 is a reduction in complexity for realizing a waterproof device with a manual user input function. For example, the interface apparatus 10 does not require any openings to the housing and thus will not require any additional sealing because the housing is practically permanently hermetically sealed. At least a second advantage of the user interface apparatus 10 requires a relatively simple electronic system for processing user input that is reduced to the first strain sensor 32 and the second strain sensor 36, the analog signal processing circuitry 52, and the digital processor 50 to differentiate output from the first strain sensor 32 and the second strain sensor 36.

In some embodiments, the elongated pad 26 may be integrated into the housing 12 or may be embossed bumping over the exterior surface 20. Certain embodiments according to the present disclosure may include the following:
The position values are contiguous within a range of the length of the elongated pad.
The position resolution is implementation specific, for example, 0.5 mm.
The first and second electrical signals position while the pointing instrument touches the elongated pad 26 with the force exceeding a predetermined touch threshold.
The pointing instrument can slide along the elongated pad 26 causing the contiguous position incremented values to be output or to point to a discrete position to cause a single position value to be output.
A direction of pointing instrument travel may be detected by comparing immediately previous press locations with a present press location.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A user interface apparatus comprising:
a housing having an interior surface and an exterior surface;
an elongated pad that is disposed over the interior surface and extends outwardly from the exterior surface;
a first strain sensor aligned with a proximal end of the elongated pad and fixed to the interior surface, wherein the first strain sensor is configured to generate a first electrical signal that is at a maximum value when force is applied directly to the proximal end of the elongated pad and decreasing in value as force is progressively applied to the elongated pad at an increasing distance from the proximal end; and
a second strain sensor aligned with a distal end of the elongated pad and fixed to the interior surface, wherein the second strain sensor is configured to generate a second electrical signal that is at a maximum value when force is applied directly to the distal end of the elongated pad and decreasing in value as force is progressively applied to the elongated pad at an increasing distance from the distal end.

2. The user interface apparatus of claim 1 further comprising analog signal processing circuitry coupled to outputs of the first strain sensor and the second strain sensor and configured to amplify and filter the first electrical signal and the second electrical signal.

3. The user interface apparatus of claim 1 further comprising a digital processor coupled to the analog signal processing circuitry and configured to determine a location of a press along a longitudinal axis of the elongated pad based on the first electrical signal and the second electrical signal, wherein the digital processor compares the magnitude of the first electrical signal to the magnitude of the second electrical signal to determine the location of the press.

4. The user interface apparatus of claim 3 wherein the digital processor is coupled to user circuitry and is further configured to output the direction of press travel to the user circuitry based on comparing immediately previous press locations with a present press location.

5. The user interface apparatus of claim 1 wherein the first strain sensor and the second strain sensor are fixed to the interior surface by way of a support structure.

6. The user interface apparatus of claim 5 wherein the support structure comprises a proximal foot that presses against a proximal mounting ledge and forces a portion of the support structure that holds the first strain sensor against the interior surface adjacent to the proximal end of the elongated pad and a distal foot that presses against a distal mounting ledge that holds the second strain sensor against the interior surface adjacent to the distal end of the elongated pad.

7. The user interface apparatus of claim 5 wherein the support structure comprises mechanical fasteners to pull and hold the first strain sensor against the interior surface adjacent to the proximal end of the elongated pad and to pull and hold the second strain sensor against the interior surface adjacent to the distal end of the elongated pad.

8. The user interface apparatus of claim 1 wherein the housing is hermetically sealed.

9. The user interface apparatus of claim 8 wherein the housing is waterproof up to a water depth of 100 meters.

10. The user interface apparatus of claim 8 wherein the housing is waterproof up to a water depth of 300 meters.

11. A method for interacting with a user interface apparatus having an interior surface and an exterior surface, an elongated pad that is disposed over the interior surface and extends outwardly from the exterior surface, a first strain sensor aligned with a proximal end of the elongated pad and fixed to the interior surface, a second strain sensor aligned with a distal end of the elongated pad and fixed to the interior surface, the method comprising:
detecting a first electrical signal from the first strain sensor when the elongated pad is pressed; and
detecting a second electrical signal from the second strain sensor when the elongated pad is pressed, wherein the first strain sensor generates a first electrical signal that is at a maximum value when force is applied directly to the proximal end of the elongated pad and decreasing in value as force is progressively applied to the elongated pad at an increasing distance from the proximal end, and the second strain sensor generates a second electrical signal that is at a maximum value when force is applied directly to the distal end of the elongated pad and decreasing in value as force is progressively applied to the elongated pad at an increasing distance from the distal end.

12. The method for interacting with the user interface apparatus of claim 11 further comprising determining the location of the press based on the first electrical signal and the second electrical signal.

13. The method for interacting with the user interface apparatus of claim 11 further comprising detecting a direction of press travel by comparing immediately previous press locations with a present press location.

14. An electronic system for processing user input, comprising:
a user interface apparatus configured to generate a first electrical. signal and a second electrical signal from a first strain sensor and a second strain sensor, respectively, that are stressed by an elongated pad pressed manually by a user;
analog signal processing circuitry coupled to the user interface apparatus and configured to amplify and filter the first electrical signal and the second electrical signal;
a digital processor coupled to the analog signal processing circuitry, the digital processor comprising an analog-to-digital converter for converting amplified and filtered versions of the first and second electrical signals into first and second digital signals, respectively, and further configured to process the first and second digital signals to extract information that determines a location where a press occurs on the elongated pad, the processing further comprising error correction operations and other decoding that determines the direction of a sliding motion of a press along the elongated pad.

15. The electronic system of claim 14 wherein the user interface apparatus further comprises:
a housing having an interior surface and an exterior surface;
an elongated pad that is disposed over the interior surface and extends outwardly from the exterior surface;
a first strain sensor aligned with a proximal end of the elongated pad and fixed to the interior surface, wherein the first strain sensor is configured to generate a first electrical signal that is at a maximum value when force is applied directly to the proximal end of the elongated pad and decreasing in value as force is progressively applied to the elongated pad at an increasing distance from the proximal end; and
a second strain sensor aligned with a distal end of the elongated pad and fixed to the interior surface, wherein the second strain sensor is configured to generate a second electrical signal that is at a maximum value when force is applied directly to the distal end of the elongated pad and decreasing in value as force is progressively applied to the elongated pad at an increasing distance from the distal end.

16. The electronic system of claim 15 further comprising a structure comprising a proximal foot that presses against a proximal mounting ledge and forces a portion of support structure that holds the first strain sensor against the interior surface adjacent to the proximal end of the elongated pad and a distal foot that presses against a distal mounting ledge that holds the second strain sensor against the interior surface adjacent to the distal end of the elongated pad.

17. The electronic system of claim 16 wherein the support structure comprises mechanical fasteners to pull and hold the first strain sensor against the interior surface adjacent to the proximal end of the elongated pad and to pull and hold the second strain sensor against the interior surface adjacent to the distal end of the elongated pad.

18. The electronic system of claim 15 wherein the housing is hermetically sealed.

19. The electronic system of claim 18 wherein the housing is waterproof up to a water depth of 100 meters.

20. The electronic system of claim 18 wherein the housing is waterproof up to a water depth of 300 meters.
